(19) United States
(12) Patent Application Publication
(10) Pub. No.: US 2024/0264277 A1
(43) Pub. Date: Aug. 8, 2024

(54) METHOD OF BUILDING A LiDAR SEMANTIC SEGMENTATION MODEL THROUGH TWO-STEP DOMAIN ADAPTATION AND LiDAR-BASED OBJECT PERCEPTION APPARATUS USING THE SAME

(71) Applicants: HYUNDAI MOTOR COMPANY, Seoul (KR); KIA CORPORATION, Seoul (KR)

(72) Inventors: Mu Gwan Jeong, Seoul (KR); Soo Kyung Ryu, Seoul (KR); Sang Won Hwang, Seoul (KR)

(73) Assignees: HYUNDAI MOTOR COMPANY, Seoul (KR); KIA CORPORATION, Seoul (KR)

(21) Appl. No.: 18/523,163

(22) Filed: Nov. 29, 2023

(30) Foreign Application Priority Data
Feb. 8, 2023 (KR) 10-2023-0016795

(51) Int. Cl. G01S 7/48; G01S 17/89

(52) U.S. Cl. CPC G01S 7/4802; G01S 17/89

(57) ABSTRACT

A LiDAR semantic segmentation method and a LiDAR-based object perception apparatus. According to an embodiment of the present disclosure, a method for constructing a LiDAR semantic segmentation model through two-step domain adaptation includes converting a first LiDAR data set of a first domain to obtain a second LiDAR data set of a second domain, as a sensor domain adaptation step, performing a machine learning with the second LiDAR data set as training data to obtain a first semantic segmentation model of an artificial intelligence model, and performing a feature domain adaptation for the first semantic segmentation model using target data to obtain a second semantic segmentation model.

### CROSS-REFERENCE TO RELATED APPLICATION

The present application claims priority to Korean Patent Application No. 10-2023-0016795, filed on Feb. 8, 2023, the entire contents of which is incorporated herein by reference in its entirety.

### BACKGROUND

### Technical Field

The present disclosure relates to a LiDAR semantic segmentation method and a LiDAR-based object perception apparatus using the same.

### Description of the Related Art

Autonomous driving requires object perception using a sensor, and object perception technology using LiDAR has recently been developed.

Object perception by LiDAR includes semantic segmentation for point cloud obtained through LiDAR sensor.

Recently, a deep learning model has been developed for semantic segmentation of the LiDAR point cloud.

Training data is required for deep learning models, and the greater amount of training data, the higher accuracy of segmentation.

However, in order to secure a large amount of training data, amount of time and cost are required.

Although there is disclosed LiDAR data set, it is inappropriate to apply it to a specific domain-based deep learning model due to domain differences.

### SUMMARY

The present disclosure aims to solve at least one of the problems of the related art described above.

Provided is a method for constructing a semantic segmentation model using an existing data set while overcoming domain differences and an object perception apparatus using the same.

According to an embodiment of the present disclosure, a method for constructing a LiDAR semantic segmentation model through two-step domain adaptation comprises converting, by a processor, a first LiDAR data set of a first domain to obtain a second LiDAR data set of a second domain, performing, by the processor, a machine learning with the second LiDAR data set as training data to obtain a first semantic segmentation model of an artificial intelligence model, and performing, by the processor, a feature domain adaptation for the first semantic segmentation model utilizing target data to obtain a second semantic segmentation model.

In at least one embodiment of the present disclosure, the converting of the first LiDAR data set includes converting, by the processor, vertical coordinate values of the first LiDAR data set according to vertical coordinates of the second domain.

In at least one embodiment of the present disclosure, the converting of the first LiDAR data set includes converting, by the processor, the first LiDAR data set into a first range view image having a first horizontal resolution (a number of pixels) and a first vertical resolution (a number of channels), and converting, by the processor, the first range view image into a second range view image having a horizontal resolution and a vertical resolution corresponding to the second domain.

In at least one embodiment of the present disclosure, the converting of the first LiDAR data set includes obtaining, by the processor, the second range view image by mapping, by the processor, the first range view image to a range view image frame of a second horizontal resolution (a number of pixels).

In at least one embodiment of the present disclosure, the first semantic segmentation model includes a deep learning network which has n (integer) encoder layers, and the second horizontal resolution is a number above a number obtained by dividing 360 degrees by a horizontal scan resolution (angle) of the second domain among multiples of 2 to the power of n.

In at least one embodiment of the present disclosure, the obtaining of the second range view image, in response to the first horizontal resolution being greater than the second horizontal resolution and a plurality of pixels of the first range view image are mapped to one pixel of the second range view image, includes performing, by the processor, a mapping by selecting, by the processor, a LiDAR point having a smaller distance coordinate value among LiDAR points corresponding to the plurality of pixels.

In at least one embodiment of the present disclosure, the converting of the first LiDAR data set further includes obtaining, by the processor, the second range view image by converting, by the processor, the first range view image into a range view image of a second vertical resolution (a number of channels).

In at least one embodiment of the present disclosure, the converting of the first LiDAR data set further includes converting, by the processor, the first range view image into a “pitch-density function” domain, dividing, by the processor, a pitch axis into equal parts by the second vertical resolution (a number of channels), and obtaining, by the processor, the second range view image from a density function value corresponding to the equal parts.

In at least one embodiment of the present disclosure, a density function value for an equal part that does not have the corresponding density function value among the equal parts is determined to be 0 (zero).

In at least one embodiment of the present disclosure, the converting of the first LiDAR data set further includes masking, by the processor, an occlusion part of the first range view image corresponding to the second domain to be excluded from the machine learning.

A LiDAR-based object recognition apparatus according to an embodiment of the present disclosure comprises a LiDAR sensor that obtains cloud points for a surrounding environment, a computer-readable recording medium storing a computer program configured to perform a segmentation on the cloud points according to a LiDAR semantic segmentation model, and a processor executing the computer program, wherein the LiDAR semantic segmentation model is constructed by obtaining a second LiDAR data set of a second domain by converting a first LiDAR data set of a first domain, obtaining a first semantic segmentation model of an artificial intelligence model by performing a machine learning with the second LiDAR data set as training data, and obtaining a second semantic segmentation model by performing a feature-domain adaptation for the first semantic segmentation model utilizing target data.

In at least one embodied apparatus of the present disclosure, the LiDAR semantic segmentation model is further constructed by converting vertical coordinate values of the first LiDAR data set according to vertical coordinates of the second domain.

In at least one embodied apparatus of the present disclosure, the LiDAR semantic segmentation model is further constructed by converting the first LiDAR data set into a first range view image having a first horizontal resolution (a number of pixels) and a first vertical resolution (a number of channels), and converting the first range view image into a second range view image having a horizontal resolution and a vertical resolution corresponding to the second domain.

In at least one embodied apparatus of the present disclosure, the LiDAR semantic segmentation model is further constructed by obtaining the second range view image by mapping the first range view image to a range view image frame of a second horizontal resolution (a number of pixels).

In at least one embodied apparatus of the present disclosure, the first semantic segmentation model includes a deep-learning network having n (integer) encoder layers, wherein the second horizontal resolution may be a number that is directly above a number obtained by dividing 360° by a horizontal scan resolution (angle) of the second domain among multiples of 2 to the power of n.

In at least one embodied apparatus of the present disclosure, in the obtaining of the second range view image, and in response to the first horizontal resolution being greater than the second horizontal resolution and a plurality of pixels of the first range view image are mapped to one pixel of the second range view image, a LiDAR point having a smaller distance coordinate value among LiDAR points corresponding to the plurality of pixels is selected for mapping.

In at least one embodied apparatus of the present disclosure, the LiDAR semantic segmentation model is further constructed by obtaining the second range view image by converting the first range view image into a range view image of a second vertical resolution (a number of channels).

In at least one embodied apparatus of the present disclosure, the converting of the first range view image includes converting the first range view image into a “pitch-density function” domain, dividing a pitch axis into equal parts by the second vertical resolution (the number of channels), and obtaining the second range view image from a density function value corresponding to the equal parts.

In at least one embodied apparatus of the present disclosure, a density function value of an equal part that does not have a corresponding density function value among the above-described equal parts is determined to be 0 (zero).

In at least one embodied apparatus of the present disclosure, the LiDAR semantic segmentation model is further constructed by masking an occlusion part of the first range view image corresponding to the second domain to be excluded from the machine learning.

A semantic segmentation model may be constructed using an existing data set despite a domain difference.

It is possible to secure an object perception device using such a model.

### BRIEF DESCRIPTION OF THE DRAWINGS

FIG. 1 illustrates a semantic segmentation model construction process according to an embodiment of the present disclosure.

FIG. 2 illustrates a deep learning network according to an embodiment of the present disclosure.

FIGS. 3A and 3B illustrate vertical coordinates for a first domain (a source domain) and a second domain (a target domain), respectively.

FIG. 4 illustrates a 2D range view image.

FIGS. 5A to 5C illustrate a horizontal resolution adaptation result according to an embodiment of the present disclosure.

FIGS. 6A to 6C illustrate a horizontal resolution adaptation result for a hypothetical situation according to an embodiment of the present disclosure.

FIG. 7 illustrates a process of extracting data from a source data as many as the number of channels (128 channels) of a target domain for a vertical resolution adaptation according to an embodiment of the present disclosure.

FIGS. 8A and 8B illustrate a vertical resolution adaptation result according to an embodiment of the present disclosure.

FIG. 9 is a view for explaining an occlusion adaptation according to an embodiment of the present disclosure.

FIG. 10 illustrates a segmentation result obtained by applying a semantic segmentation model according to an embodiment of the present disclosure.

FIG. 11 shows an object perception apparatus according to an embodiment of the present disclosure.

### DETAILED DESCRIPTION

The present disclosure may be modified in various ways and have various embodiments, and specific embodiments will be illustrated and described in the drawings. However, this is not intended to limit the present disclosure to specific embodiments, and it should be understood that the present disclosure includes all modifications, equivalents, and replacements included on the idea and technical scope of the present disclosure.

The suffixes “module” and “unit” used in the present specification are used only for name division between components and should not be construed as being physically and chemically divided or separated or assuming that they may be so divided or separated.

Terms including ordinals such as “first,” “second,” etc., may be used to describe various elements, but the elements are not limited by the terms. The terms are used only for the purpose of distinguishing one component from another component.

The term “and/or” is used to include all instances of any clause agreement of a plurality of items to be included. For example, “A and/or B” includes all three cases such as “A”, “B”, and “A and B”.

When it is stated that a component is “connected” or “connected” to another component, it should be understood that the component may be directly connected or connected to the other component, but another component may exist therebetween.

The terminology used herein is for the purpose of describing particular embodiments only and is not intended to be limiting of the disclosure. Singular expressions include plural expressions, unless the context clearly indicates otherwise. In the present application, it should be understood that the term “include” or “have” indicates that a feature, a number, a step, an operation, a component, a part, or a combination thereof described in the specification is present, but does not exclude the possibility of existence or addition of one or more other features, numbers, steps, operations, components, parts, or combinations thereof in advance.

Unless otherwise defined, all terms used herein, including technical or scientific terms, have the same meaning as that generally understood by those skilled in the art. It will be understood that terms, such as those defined in commonly used dictionaries, should be interpreted as having a meaning that is consistent with their meaning in the context of the relevant art and will not be interpreted in an idealized or overly formal sense unless expressly so defined herein.

In addition, a unit or a control unit is a term widely used for naming a controller for controlling a vehicle specific function, but does not mean a generic function unit. For example, each unit or control unit may include a communication device communicating with another controller or sensor to control a function in charge, a memory storing an OS or logic command, input/output information, and the like, and one or more processors performing determination, calculation, determination, and the like necessary for controlling a function in charge.

First, the accompanying drawings will be briefly described.

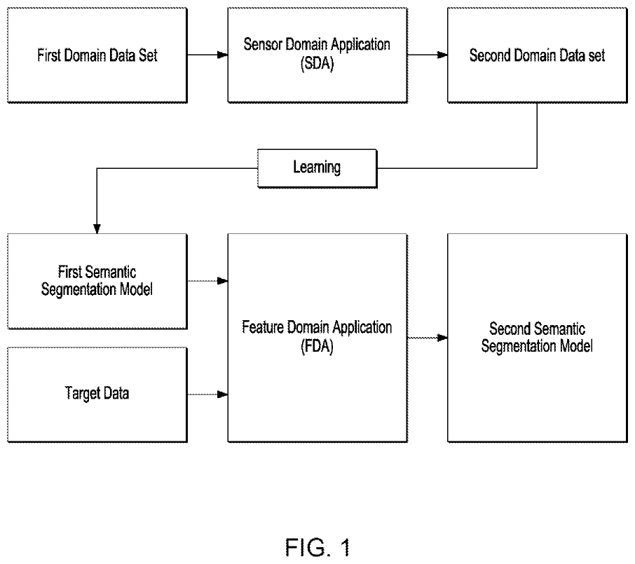

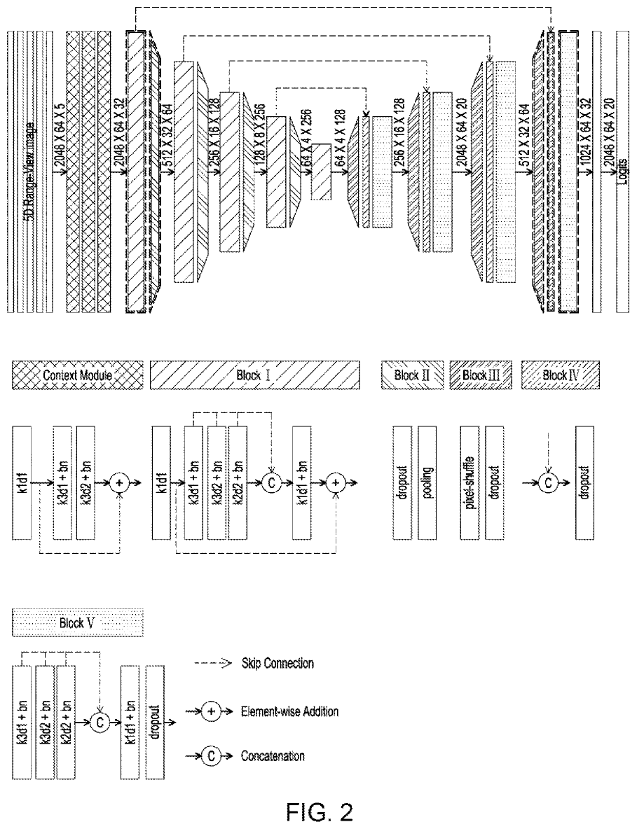

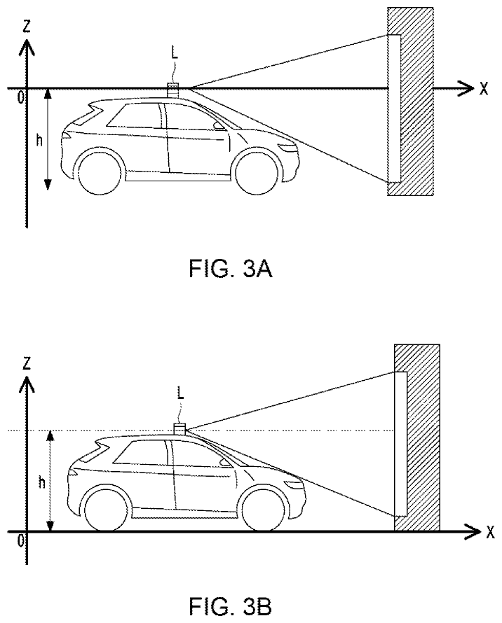

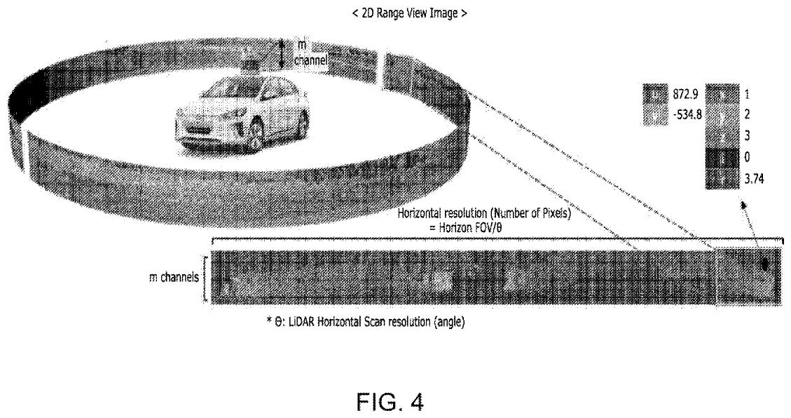

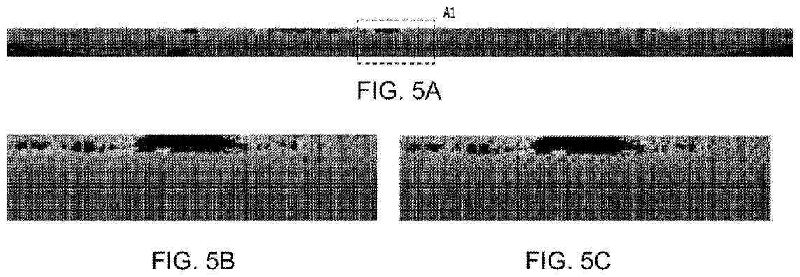

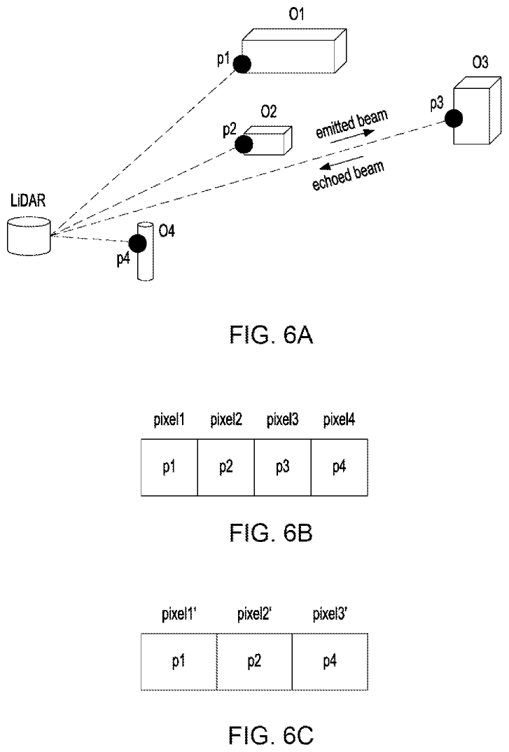

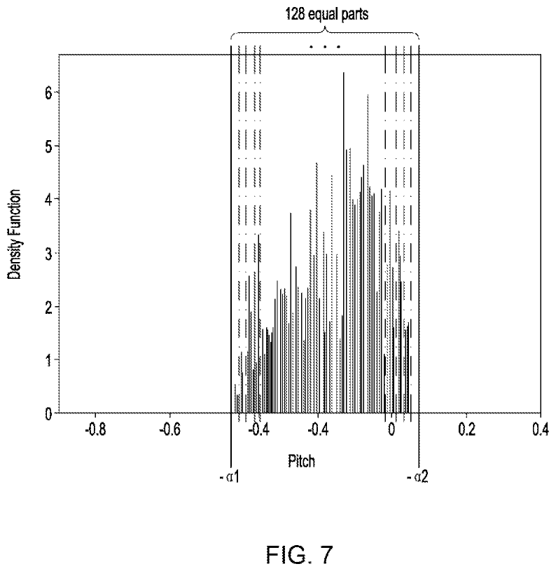

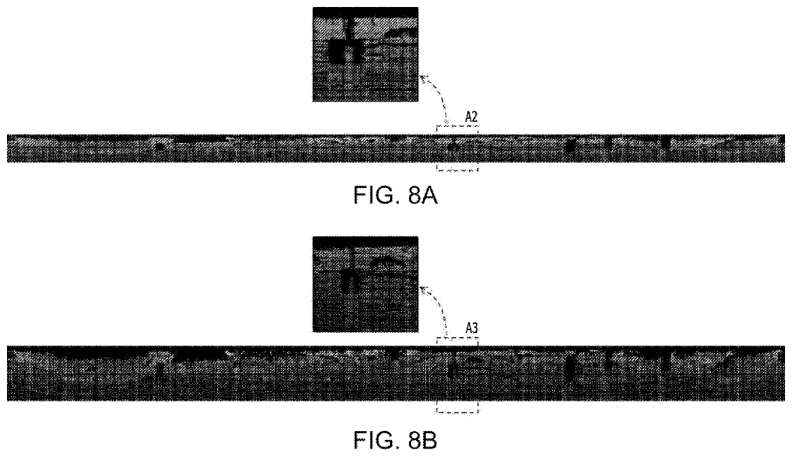

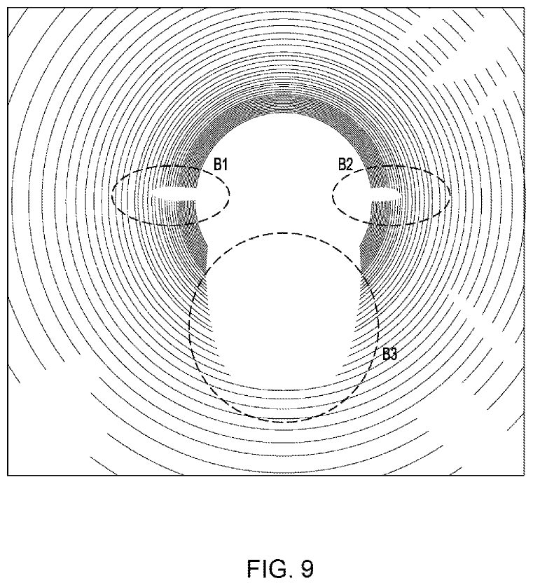

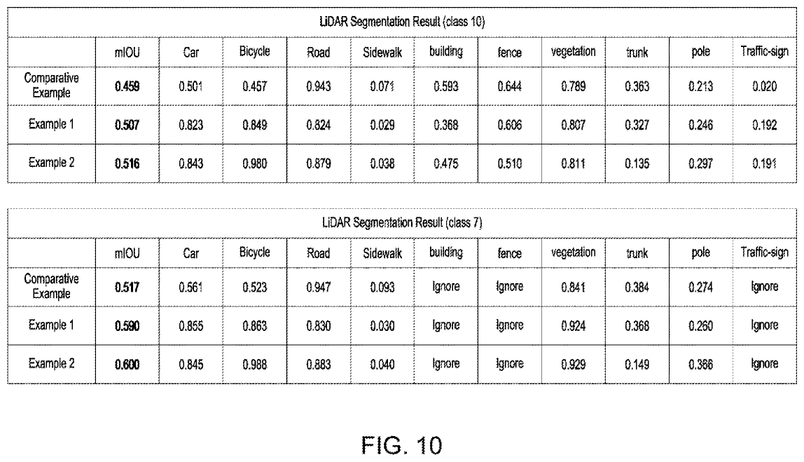

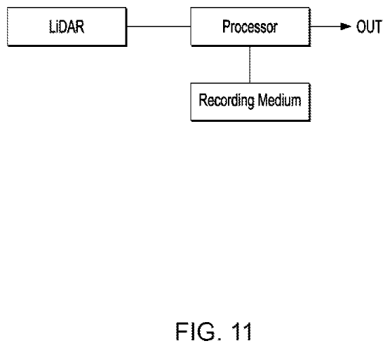

FIG. 1 illustrates a semantic segmentation model construction process according to an embodiment of the present disclosure, and FIG. 2 illustrates a deep learning network according to an embodiment of the present disclosure. FIGS. 3A and 3B illustrate vertical coordinates of a first domain (source domain) and a second domain (target domain), respectively. FIG. 4 illustrates a two-dimensional range view image. FIGS. 5A to 5C illustrate a result of horizontal resolution adaptation according to an embodiment of the present disclosure, and FIGS. 6A to 6C illustrate a result of horizontal resolution adaptation according to an embodiment of the present disclosure for a hypothetical situation. FIG. 7 illustrates a process of extracting data as many as the number of channels (128 channels) of a target domain from source data for vertical resolution adaptation according to an embodiment of the present disclosure, and FIGS. 8A and 8B illustrates a vertical resolution adaptation result according to an embodiment of the present disclosure. FIG. 9 is a diagram for describing occlusion adaptation according to an embodiment of the present disclosure, and FIG. 10 is a diagram illustrating a segmentation result obtained by applying a semantic segmentation model according to an embodiment of the present disclosure. Meanwhile, FIG. 11 shows an object perception apparatus according to an embodiment of the present disclosure.

Referring to FIG. 1, a sensor domain adaptation is performed on a data set (hereinafter, referred to a first data set) of a first domain to obtain a data set (hereinafter, referred to a second data set) of a second domain.

Here, the first data set and the second data set may be in a form of point cloud data.

The first data set may be an open data set or a ground-truth (GT) data set. Without limited thereto, for example, the first data set may be a KITTI data set. In the present embodiment, the KITTI data set is used, but the present disclosure is not limited thereto. For example, nuScene, Cityscape, Waymo, and Argoverse datasets may be used.

The first domain and the second domain may differ from each other in horizontal scan resolution (angle), vertical resolution, channel number, etc. In addition, the first domain and the second domain may have different types or sizes of vehicles mounted thereon and mounting positions thereof, for example. However, this is merely an example, and the present disclosure is not limited thereto.

Hereinafter, a sensor domain adaptation will be described in detail.

In the present embodiment, the sensor domain adaptation includes a vertical coordinate adaptation, a horizontal resolution adaptation, and a vertical resolution adaptation.

As shown in FIG. 3A, a first data set may have a zero point of a vertical coordinate at a position of a sensor L.

Also, the zero point of the vertical coordinate in a second domain, which is the target domain, may be aligned with the ground as shown in FIG. 3B.

A vertical coordinate adaptation may be achieved by coordinate-converting the vertical coordinate value of the first data set with respect to the zero point of the second domain.

Next, a horizontal resolution adaptation process will be described.

For horizontal resolution adaptation, the first data set is converted into a range view image (hereinafter, referred to a first range view image).

The first range view image is obtained by converting the first data set into a two-dimensional image. The first range view image has a horizontal length corresponding to a horizontal FOV (Field of View) of a corresponding LiDAR sensor, and has a vertical length corresponding to a number of vertically arranged channels, that is, a number of channels. It may be defined as a 2D image data obtained by mapping each of all point data of the first data set to a corresponding pixel. One pixel of the range view image may include an x coordinate value, a y coordinate value, a z coordinate value, a reflectivity intensity, an r value (i.e., a distance to a point), and the like as corresponding point data.

A first range view image, as described above, can have a first horizontal resolution (a number of pixels) and a vertical resolution (a number of channels).

The first horizontal resolution can be equal to an integer obtained by dividing a horizontal FOV (angle) of the corresponding LiDAR sensor by a horizontal scan resolution (angle).

That is, for example, if it is assumed that the horizontal FOV is 360 degrees and the horizontal scan resolution is 0.2 degree, the horizontal resolution of the range view image is 1800 pixels.

The first vertical resolution may be equal to the number of channels of the corresponding LiDAR sensor.

A horizontal resolution adaptation may include a step of mapping a first range view image to a range view image frame of a second horizontal resolution (a number of pixels) to obtain a second range view image.

Here, the second horizontal resolution may be determined to be a number directly above a number obtained by dividing the horizontal FOV (angle) by a horizontal scan resolution (angle) of the second domain among multiples of 2ⁿ (i.e., 2 to the power of n) when the first semantic segmentation model includes a deep learning network in which a number of encoder layers is n. It has been confirmed that determining the second horizontal resolution in this way is advantageous in reducing point loss.

For example, when n is 4, the horizontal scan resolution of the second domain is 0.2 degrees, and the horizontal FOV is 360 degrees, the second horizontal resolution is 1808 pixels.

FIG. 5A illustrates a first range view image, and FIG. 5B and FIG. 5C shows a result of the A1 part of FIG. 5A when the first range view image is converted into a second range view through a horizontal resolution adaptation. Here, FIG. 5B is a case where the second horizontal resolution is 1808, and FIG. 5C is a case where the second horizontal resolution is 2048. As shown in FIG. 5B, when the second horizontal resolution is 1808, it may be seen that the point loss is less.

A process of obtaining a second range view image by mapping a first range view image to a range view image frame having a second horizontal resolution (a number of pixels) will be described in detail with reference to FIGS. 6A to 6C.

FIG. 6A conceptually illustrates an example of obtaining point cloud data through a LIDAR sensor. In this example, the LiDAR sensor is a single-channel sensor, four objects O1 to O4 are present in a horizontal FOV range, and one point is obtained for each object, and thus a total of four points p1 to p4 are obtained. In this example, one point is obtained for every horizontal scan angle of the LiDAR sensor.

FIG. 6B illustrates pixels and data obtained by converting the point cloud obtained as shown in FIG. 6A to a first range view image. As shown in FIG. 6B, the first horizontal resolution of the first range view image according to this example is 4 pixels, and one point data is matched to each pixel.

FIG. 6C illustrates a second range view image obtained by mapping the first range view image of FIG. 6A to a range view image frame having a second horizontal resolution of 3 pixels as pixels and data. In the mapping process, it can be seen that the first pixel pixel1 and the fourth pixel pixel4 of the first range view image are mapped to the first pixel pixel1′ and the third pixel pixel3′ of the second range view image as they are.

However, since the second pixel pixel2 and the third pixel pixel3 of the first range view image correspond to the second pixel pixel2′ of the second range view image, one of the point data of the second pixel pixel2 and the third pixel pixel3 of the first range view image should be selected. In the present embodiment, a data value r, that is, a data value p2 of a point having a smaller distance, of the point data p2 and p3 of the second pixel pixel2 and the third pixel pixel3 of the first range view image is selected and mapped to the second pixel pixel2′ of the second range view image.

That is, in the present embodiment, when the first horizontal resolution is greater than the second horizontal resolution and a plurality of pixels of the first range view image are mapped to one pixel of the second range view image, a LiDAR point having a small distance coordinate value is selected among LiDAR points corresponding to the plurality of pixels and the mapping is performed.

The vertical resolution adaptation will now be described in detail.

The vertical resolution adaptation is to convert the first range view image of the first vertical resolution (a number of channels) into the range view image of the second vertical resolution (a number of channels).

To this end, the vertical resolution adaptation includes steps of converting the first range view image into a “pitch-density function” domain, and dividing its pitch axis to equal parts by the second vertical resolution (a number of channels) to obtain the second range view image from density functions value corresponding to the equal parts.

Here, a density function value for an equal part in which a corresponding density function value does not exist may be determined to be zero. That is, an empty channel generated according to the conversion from the first vertical resolution to the second vertical resolution is set to 0 (zero) as its data value.

FIG. 7 illustrates an example of converting the first range view image into the “pitch-density function” domain.

In FIG. 7, the “pitch” axis, which is the horizontal axis, represents a pitch angle based on the LiDAR sensor, and “−α1” and “α2” represent a vertical FOV.

FIG. 7 illustrates an example in which, when the second vertical resolution (the number of channels) is 128, the data region of the pitch axis is divided to equal parts by 128 in order to obtain the unknown second range view.

FIG. 8A illustrates the first range view image having the first vertical resolution of 64, and FIG. 8B illustrates a result of converting the first range view image of FIG. 8A into the second range view image having the second vertical resolution of 128.

As shown in FIGS. 8A and 8B, the portion A3 of the second range view image corresponds to the region A2 of the first range view image, and it can be seen from the region A3 that the data value of a pixel corresponding to the empty channel is processed as 0 (represented as black in the image).

The occlusion adaptation will now be described in detail.

The first domain and the second domain are different in size and shape of a vehicle on which the LiDAR sensor is mounted, and may be different in the mounting position of the LiDAR sensor. Therefore, there may be a difference in occlusion in the point cloud. The occlusion adaptation step is a sort of domain adaptation for such occlusion differences between two domains.

In the present embodiment, a region corresponding to at least one occlusion of the second domain in the first range view image, that is, data of pixels, is masked to exclude the data from machine learning.

Exemplarily, the masking process may delete corresponding data or change the corresponding data to 0 (zero).

FIG. 9 illustrates occlusions B1 to B3 of the second domain. A region of the first range view image corresponding to the occlusions B1 to B3 of FIG. 9 may be found and data of the corresponding region may be masked.

Through the vertical coordinate adaptation, the resolution adaptation, and the occlusion adaptation, the first range view image is converted into the second range view image having vertical coordinate values aligned with the second domain, the resolution is converted to the resolution of the second domain, and pixels corresponding to the occlusions are masked, thereby obtaining the second range view image.

The second range view image may be converted into a data format of point cloud, and thus a second data set is obtained.

Referring back to FIG. 1, when the sensor domain adaptation is completed and the second data set converted from the first data set, which is the source data, is obtained, the second data set is used as training data to machine-learn a semantic segmentation computer model, which is an artificial intelligence model, to obtain a first semantic segmentation model.

In this embodiment, the artificial intelligence model is a deep learning model including a deep learning network as shown in FIG. 2, but is not necessarily limited thereto.

In addition, SalsaNext is used for the deep learning network of the present embodiment, but the present disclosure is not limited thereto.

The feature domain adaptation is performed on the first semantic segmentation model, thereby obtaining a second semantic segmentation model as shown in FIG. 1.

The feature domain adaptation will now be described in detail.

First, target data obtained under the second domain is used, and the target data may be data-processed suitably for the FOV of the first domain.

As an example, assuming that the vertical FOV of the first domain is in a range of “−α1” to “α2” and the vertical FOV of the second domain is in a range of “−α1−Δα” to “α2+Δα” as in the example of FIG. 7, data out of the range of “−α1” to “α2” may be excluded from the target data.

At this point, since data of channel is reduced due to exclusion of data as described above, data of channel may be added as many times as the number of channels in the second domain is reduced. In this case, the data of the added channel may be determined through interpolation.

However, the present embodiment is not limited to the above-described processing for the target data. For example, the target data may be a range view without being excluded. It can be converted into the range view without being excluded and be used as it is.

The feature domain adaptation is a process of making feature vectors, which are information encoded at the feature level of the network, into a similar distribution for the first data set and the target data.

In this embodiment, the feature domain adaptation is the same as that described in the paper “Learning to Adapt Structured Output Space for Semantic Segmentation” (Yi-Hsuan Tsai et al., 2018 IEEE/CVF Conference on Computer Vision and Pattern Recognition (CVPR)). Although the domain adaptation disclosed in the above paper relates to camera data, the domain adaptation may also be applied to LiDAR data as in the embodiment, and a detailed description thereof will be omitted.

FIG. 10 illustrates a segmentation result obtained by applying a semantic segmentation model according to an embodiment of the present disclosure.

In FIG. 10, Comparative Example is a case where only the sensor domain adaptation is applied, Example 1 is a case where the sensor domain adaptation is applied and the feature domain adaptation is applied at a single level, and Example 2 is a case where the sensor domain adaptation is applied and the feature domain adaptation is applied at multiple levels.

As shown in FIG. 10, it can be seen that the semantic segmentation performance of Example 1 was significantly improved compared to the comparative example, and it can be seen that the performance of Example 2 was the highest.

Meanwhile, the LiDAR-based object perception apparatus according to one embodiment of the present disclosure, as shown in FIG. 11, includes a LIDAR sensor for obtaining cloud points for a surrounding environment, a computer-readable recording medium in which a computer program for performing a segmentation for the cloud points according to a LiDAR semantic segmentation model is stored, and a processor for executing the computer program.

The LiDAR semantic segmentation model is a second semantic segmentation model obtained through the above-described process.

The processor of this embodiment may be, for example, any one of a computer, a microprocessor, a CPU, an ASIC, and an electronic circuit (circuitry, logic circuits), or a combination thereof.

The computer-readable recording medium of the present embodiment includes all types of storage devices in which data that can be read by a computer system is stored. Examples of the computer-readable recording medium may include a storage medium of at least one type of a memory such as a flash memory type, a hard disk type, a micro type, a card type (e.g., a secure digital (SD) card, an eXtream digital (XD) card, etc.), a Random Access Memory (RAM), a Static RAM (SRAM), a Read-Only Memory (ROM), a Programmable ROM (PROM), an Electrically Erasable PROM (EEPROM), a Magnetic RAM (MRAM), a magnetic disk, and an optical disk type. In addition, the computer-readable recording medium is a networked computer distributed in the system, computer-readable code may be stored and executed in a distributed manner.

What is claimed is:

1. A method for constructing a LiDAR semantic segmentation model through two-step domain adaptation, the method comprising:
converting, by a processor, a first LiDAR data set of a first domain to obtain a second LiDAR data set of a second domain;
performing, by the processor, a machine learning with the second LiDAR data set as training data to obtain a first semantic segmentation model of an artificial intelligence model; and
performing, by the processor, a feature domain adaptation for the first semantic segmentation model utilizing target data to obtain a second semantic segmentation model.

2. The method of claim 1, wherein the converting of the first LiDAR data set includes converting, by the processor, vertical coordinate values of the first LiDAR data set according to vertical coordinates of the second domain.

3. The method of claim 1, wherein the converting of the first LiDAR data set includes converting, by the processor, the first LiDAR data set into a first range view image having a first horizontal resolution (a number of pixels) and a first vertical resolution (a number of channels), and converting, by the processor, the first range view image into a second range view image having a horizontal resolution and a vertical resolution corresponding to the second domain.

4. The method of claim 3, wherein the converting of the first LiDAR data set further includes obtaining, by the processor, the second range view image by mapping, by the processor, the first range view image to a range view image frame of a second horizontal resolution (a number of pixels).

5. The method of claim 4, wherein the first semantic segmentation model includes a deep learning network which has n (integer) encoder layers, and the second horizontal resolution is a number above a number obtained by dividing 360 degrees by a horizontal scan resolution (angle) of the second domain among multiples of 2 to a power of n.

6. The method of claim 4, wherein the obtaining of the second range view image, in response to the first horizontal resolution being greater than the second horizontal resolution and a plurality of pixels of the first range view image are mapped to one pixel of the second range view image, includes performing, by the processor, a mapping by selecting, by the processor, a LiDAR point having a smaller distance coordinate value among LiDAR points corresponding to the plurality of pixels.

7. The method of claim 3, wherein the converting of the first LiDAR data set further includes obtaining, by the processor, the second range view image by converting, by the processor, the first range view image into a range view image of a second vertical resolution (a number of channels).

8. The method of claim 7, wherein the converting of the first LiDAR data set further includes converting, by the processor, the first range view image into a “pitch-density function” domain, dividing, by the processor, a pitch axis into equal parts by the second vertical resolution (a number of channels), and obtaining, by the processor, the second range view image from a density function value corresponding to the equal parts.

9. The method of claim 8, wherein a density function value for an equal part that does not have the corresponding density function value among the equal parts is determined to be 0 (zero).

10. The method of claim 3, wherein the converting of the first LiDAR data set further includes masking, by the processor, an occlusion part of the first range view image corresponding to the second domain to be excluded from the machine learning.

11. A LIDAR-based object perception apparatus, comprising:
a LiDAR sensor that obtains cloud points for a surrounding environment;
a computer-readable recording medium storing a computer program, which when executed causes a segmentation on the cloud points according to a LiDAR semantic segmentation model; and
a processor executing the computer program,
wherein the LiDAR semantic segmentation model is constructed by obtaining a second LiDAR data set of a second domain by converting a first LiDAR data set of a first domain, obtaining a first semantic segmentation model of an artificial intelligence model by performing a machine learning with the second LiDAR data set as training data, and obtaining a second semantic segmentation model by performing a feature-domain adaptation for the first semantic segmentation model utilizing target data.

12. The LiDAR-based object perception apparatus according to claim 11, wherein the LiDAR semantic segmentation model is further constructed by converting vertical coordinate values of the first LiDAR data set according to vertical coordinates of the second domain.

13. The LiDAR-based object perception apparatus according to claim 11, wherein the LiDAR semantic segmentation model is further constructed by converting the first LiDAR data set into a first range view image having a first horizontal resolution (a number of pixels) and a first vertical resolution (a number of channels), and converting the first range view image into a second range view image having a horizontal resolution and a vertical resolution corresponding to the second domain.

14. The LiDAR-based object perception apparatus according to claim 13, wherein the LiDAR semantic segmentation model is further constructed by obtaining the second range view image by mapping the first range view image to a range view image frame of a second horizontal resolution (a number of pixels).

15. The LiDAR-based object perception apparatus according to claim 14, wherein the first semantic segmentation model includes a deep-learning network having n (integer) encoder layers, wherein the second horizontal resolution may be a number that is directly above a number obtained by dividing 360° by a horizontal scan resolution (angle) of the second domain among multiples of 2 to a power of n.

16. The LiDAR-based object perception apparatus according to claim 14, wherein in the obtaining of the second range view image, and in response to the first horizontal resolution being greater than the second horizontal resolution and a plurality of pixels of the first range view image are mapped to one pixel of the second range view image, a LiDAR point having a smaller distance coordinate value among LiDAR points corresponding to the plurality of pixels is selected for mapping.

17. The LiDAR-based object perception apparatus according to claim 13, wherein the LiDAR semantic segmentation model is further constructed by obtaining the second range view image by converting the first range view image into a range view image of a second vertical resolution (a number of channels).

18. The LiDAR-based object perception apparatus according to claim 17, wherein the converting of the first range view image includes converting the first range view image into a “pitch-density function” domain, dividing a pitch axis into equal parts by the second vertical resolution (the number of channels), and obtaining the second range view image from a density function value corresponding to the equal parts.

19. The LiDAR-based object perception apparatus according to claim 18, wherein a density function value of an equal part that does not have a corresponding density function value among the equal parts is determined to be 0 (zero).

20. The LiDAR-based object perception apparatus according to claim 13, wherein the LiDAR semantic segmentation model is further constructed by masking an occlusion part of the first range view image corresponding to the second domain to be excluded from the machine learning.
